(19) United States
(12) Patent Application Publication
(10) Pub. No.: US 2011/0217680 A1
(43) Pub. Date: Sep. 8, 2011

(54) WRITING INSTRUMENT GRIPPING AID

(76) Inventor: Zubin Shirodkar, Plainview, NY (US)

(21) Appl. No.: 13/022,578

(22) Filed: Feb. 7, 2011

Related U.S. Application Data
(60) Provisional application No. 61/302,078, filed on Feb. 5, 2010.

(51) Int. Cl. G09B 11/02

(52) U.S. Cl. 434/166

(57) ABSTRACT

A gripping aid for use in connection with a hand-held writing, drawing and painting instrument comprising a single unitary body having a radial section capable of supporting the radial section of the hand fixedly connected to an ulnar section capable of supporting the ulnar section of the hand.

### RELATED APPLICATION

The present application claims the benefit of filing date of Provisional Application No. 61/302,078 filed Feb. 5, 2010.

### BACKGROUND OF THE INVENTION

1. Field of Invention

This invention relates to an aid for the proper gripping of a handheld instrument. More specifically, the present invention is an aid for the proper gripping of a pencil, a pen, or any other instrument used for writing, drawing, or painting.

2. Prior Art

The most stable grasp for precision and proper pencil or pen pressure during writing, is a dynamic tripod grasp. The dynamic tripod grasp requires separation of the radial and ulnar sides of the hand. The radial side of the hand, namely the thumb, index finger and middle fingers, are generally referred to as the precision side of the hand. The ulnar side of the hand namely the ring finger and the little finger are referred to as the power side of the hand.

To achieve a dynamic tripod grasp during writing, an individual must pinch the pencil or pen between the distal pads of the index finger and thumb and then rest the pencil or pen on the lateral distal inter-phalangeal joint of the middle finger. These three fingers together are the tripod. These three fingers supported by arches in the palm of the hand, utilize precise movements of rotation, flexion and extension to achieve the small movements needed for letter formation or other fine motor activities requiring accuracy. In addition, the space between the thumb and index finger, namely the web space, must be maintained in an open and circular manner to support the dynamic movements of the tripod fingers. The ulnar side of the hand stays in a flexed and quieter position so as to provide a stable base of support from which the tripod can move.

Many individuals are unable to form a dynamic tripod grasp. This is particularly true for children. While many devices have been developed in the past to help such individuals, none of such devices have been able to totally and completely solve this problem. Accordingly there is still a need for an aid that is able to allow its user to grip a pencil or a pen or any other writing or painting or drawing instrument in a dynamic tripod grasp. It is this need that the present invention actually addresses and resolves completely.

### BRIEF DESCRIPTION OF THE DRAWINGS

It is believed that the present invention will be better understood from the following detailed description taken in conjunction with the accompanying drawings, in which the numerals represent identical elements and wherein:

FIGS. 1-7 are a series of photos illustrating the use of the inventive gripping aid.

### LIST OF ELEMENTS AND THEIR RESPECTIVE IDENTIFYING NUMERALS

| NO | Element |
|---|---|
| 10 | Gripping aid |
| 20 | Radial section |
| 30 | Ulnar section |
| 32 | Slender body of said ulnar section |
| 34 | First end of slender body of said ulnar |
| | section |
| 36 | Second worm-like end of slender body of |
| | said ulnar section |
| 38 | Cavity or chamber within slender body of |
| | ulnar section |
| 39 | Meal wire or flexible spine with cavity or |
| | chamber |
| 40 | Grip body portion of radial section |
| 42 | Mounting bore |
| 44, 46 | Lateral surfaces |
| 48, 49 | Proximal end and distal end of grip body |
| 54, 56 | Concave surfaces |
| 64, 66 | Raised surfaces |
| 70 | Raised ridge |
| 71 | Proximal end of raised ridge |
| 72 | Distal end of raised ridge |
| 80 | Saddle |

### DETAILED DESCRIPTION OF PREFERRED EMBODIMENT

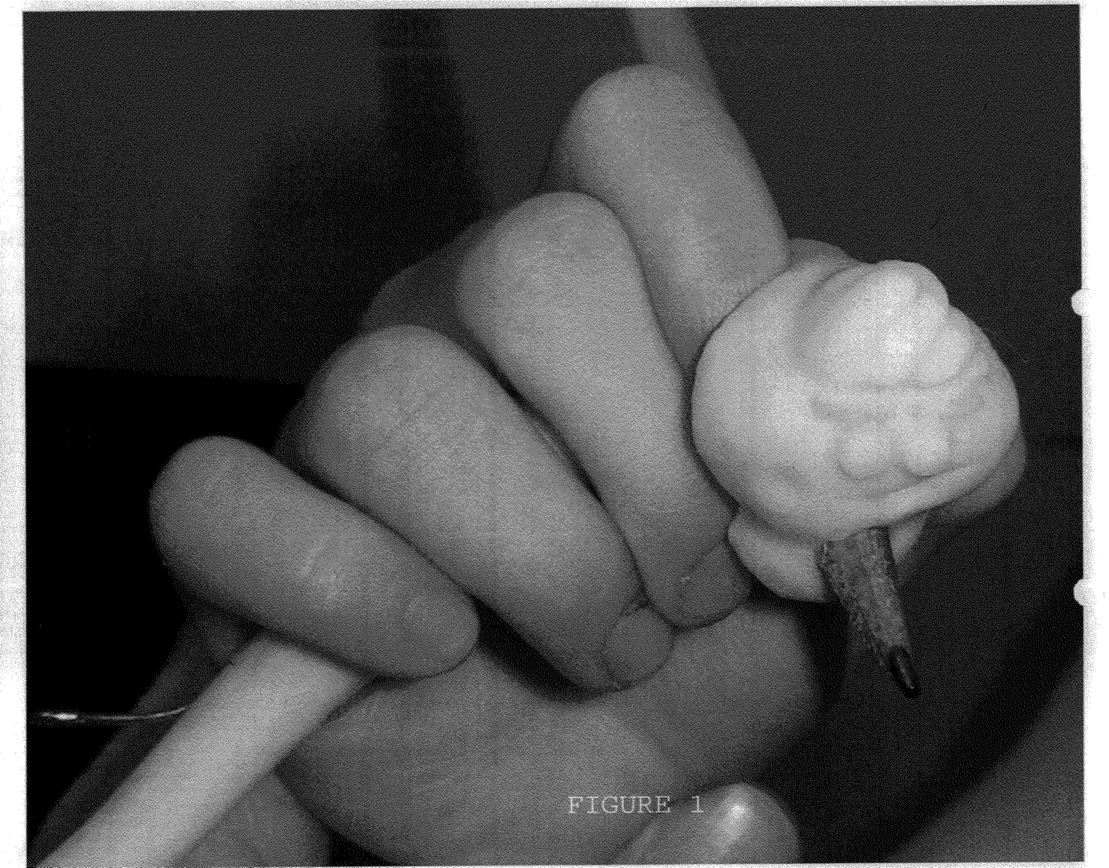

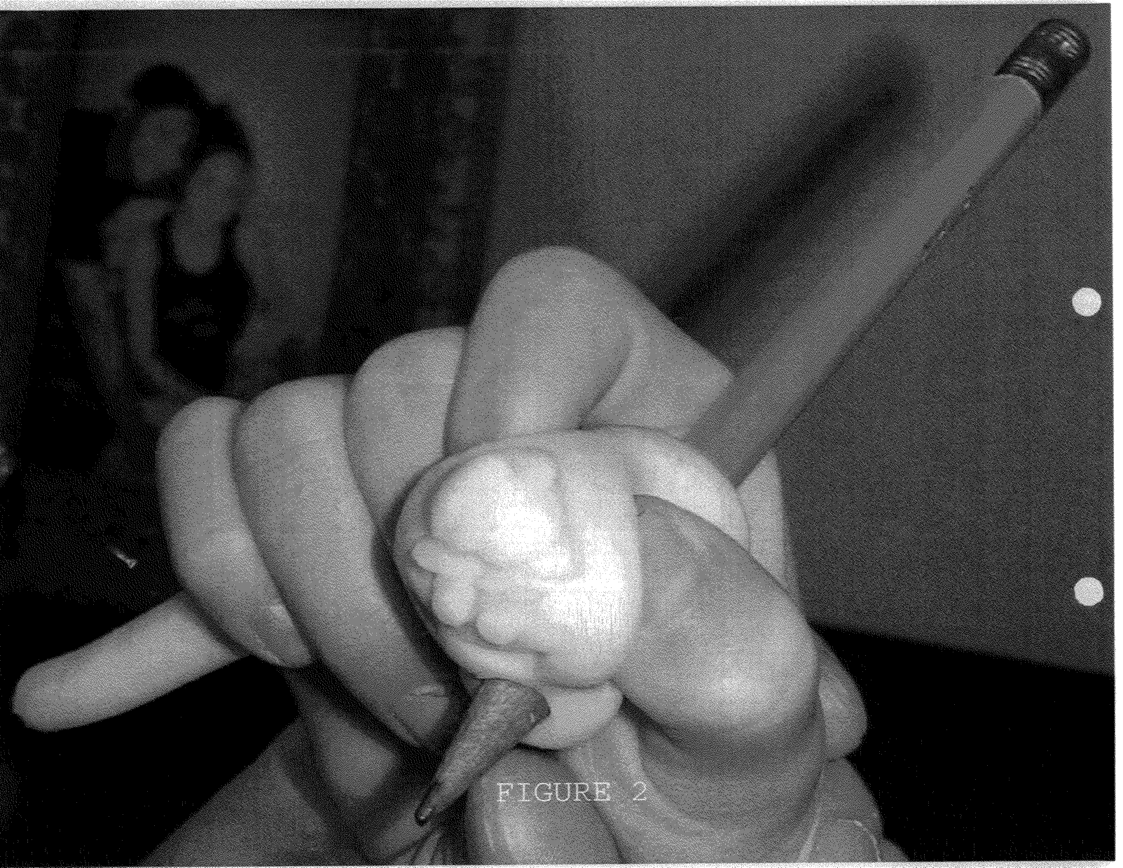

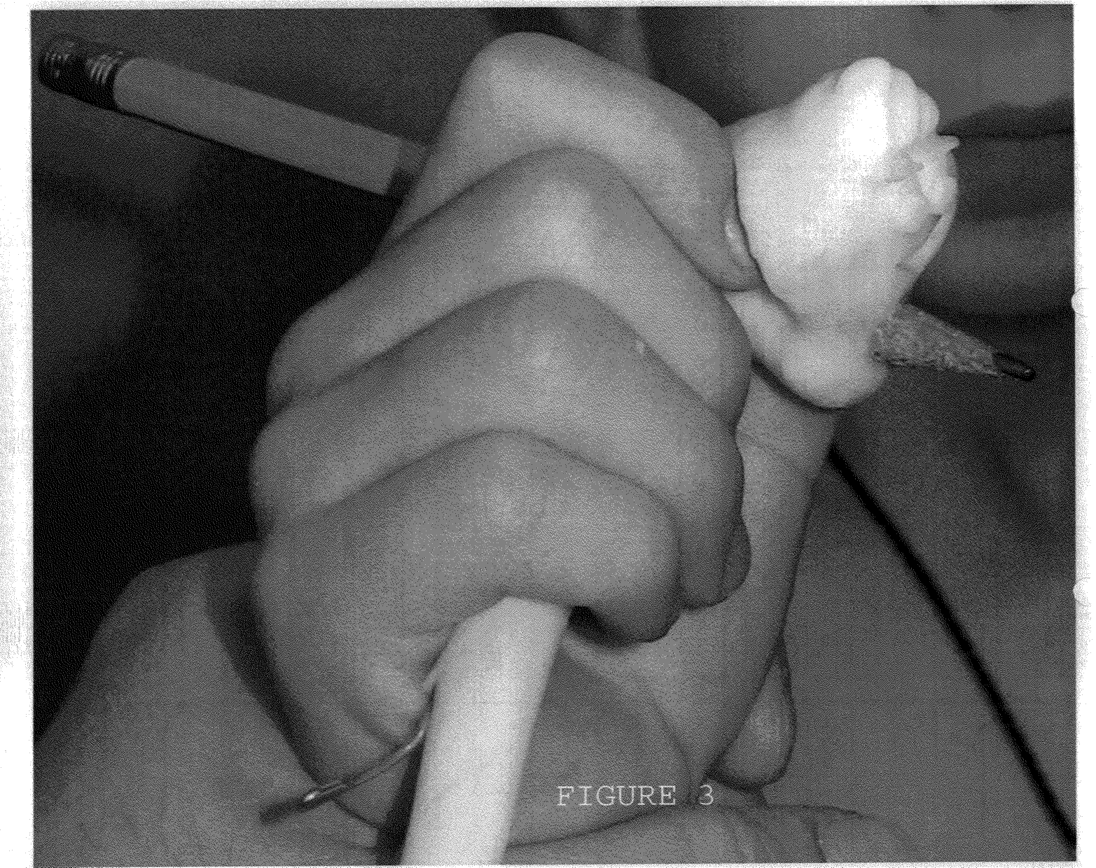

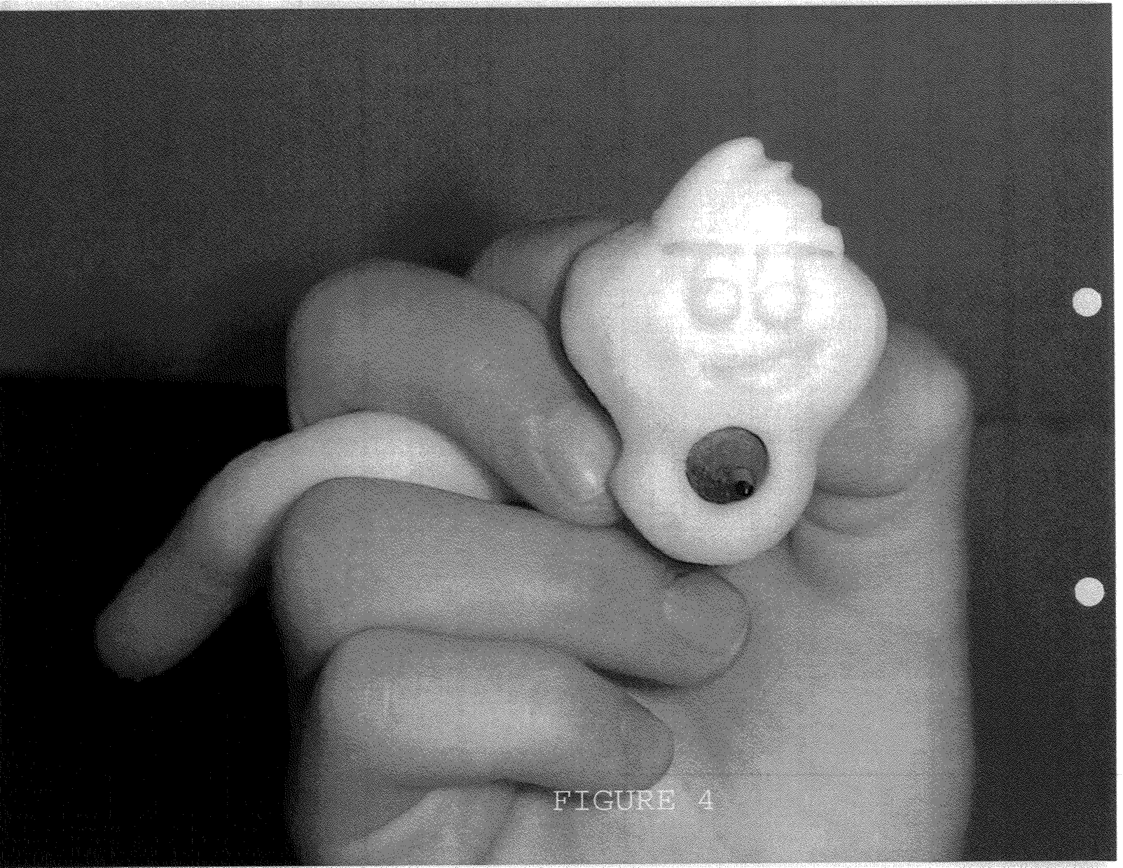

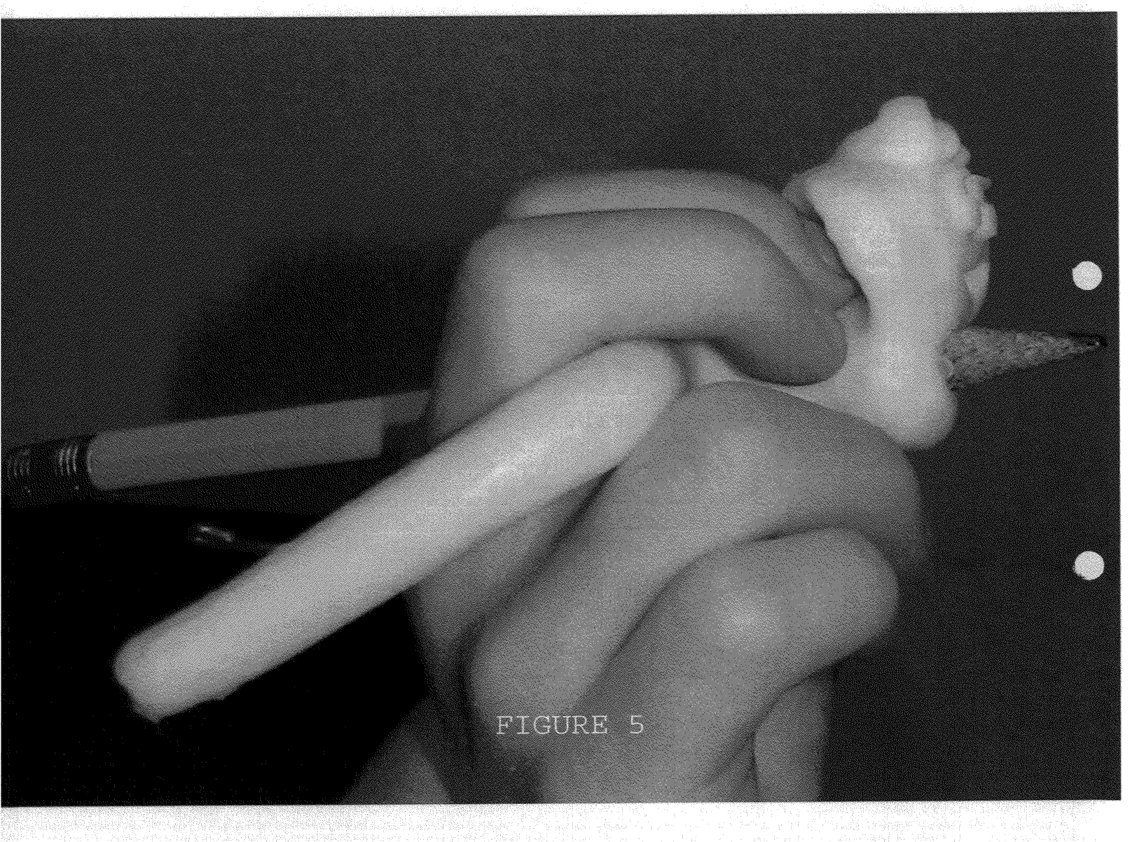

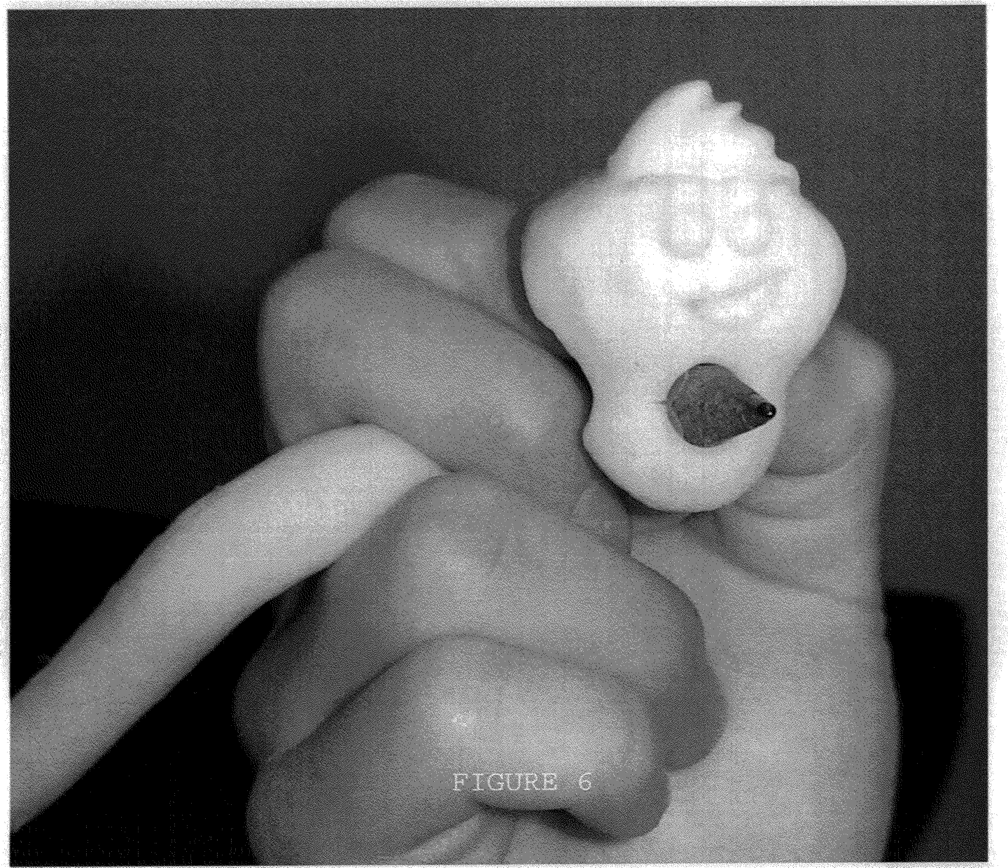

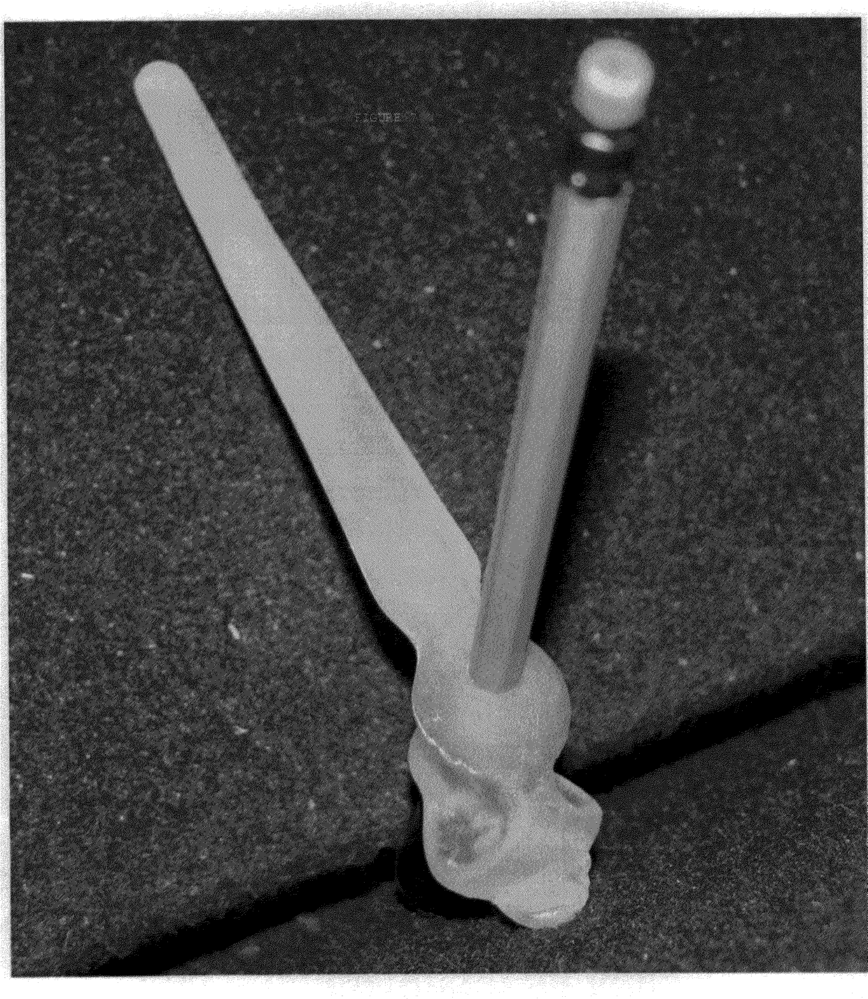

Referring more specifically to the figures, FIG. 1 through FIG. 6 generally depict a gripping aid in accordance with the present invention at 10. The gripping aid 10 is shown mounted on a pencil about to be used for writing. Further, the gripping aid is gripped by the thumb, index and middle fingers of a right hand, while simultaneously being supported by the ring and little fingers of the same hand. In this manner, the gripping aid forces the hand to achieve an optimum dynamic tripod grasp around the pencil while simultaneously maintaining the ulnar side of the hand in a flexed and quieter position so as to provide a stable base of support from which the tripod can move, over a longer period of time.

The gripping aid 10 comprises a single unitary body having a head-like section 20 designed to be held in place by the radial part of a hand when the gripping aid 10 is in use (hereinafter “the radial section 20”) fixedly connected to a tail-like or stem-like section 30 designed to be held in place by the ulnar part of the hand when the gripping aid 10 is in use (hereinafter “the ulnar section 30”).

The ulnar section 30 has a slender body 32 which has a first end 34, fixedly connected to the radial section 20, and a second snake-like or worm-like end 36 oppositely situated to the radial section 20, into which the slender body 32 tapers. Further the slender body 32 of the ulnar section 30 can be hollow with a fully enclosed cavity or chamber 38 within it, or it can be fully solid.

Functionally, the ulnar section 30 can be hard, stiff and rigid. Alternatively it can be soft and flexible. If it is soft and flexible, then it consists of any material that is soft enough to allow flexibility but strong enough to prevent breakage and allow for support of the ulnar section of the hand, when the gripping aid is in use. Further, for added flexibility and strength it can comprise a metal wire or plastic, flexible spine 39 that is either encased within the cavity 38 of the hollow slender body 32, or embedded within the fully solid slender body 32.

Finally the overall length of the ulnar section 30 is such that when the gripping aid 10 is set in the hand for use, the ulnar part of said hand, i.e. the ring and little fingers of the hand, can either fully wrap around the outer surface of, or be interwoven or intertwined with, the slender body 32. Optionally, the length can be such that when the ulnar part of the hand is wrapped around the slender body 32, the worm-like end 36 is either hidden within the hand such that the ulnar section 30 of the gripping aid 10 is not visible; or the worm like end 36 extends beyond the hand or fingers and is fully visible.

As was set forth herein above, the ulnar section 30 of the gripping aid 10 is fixedly connected to the radial section 20.

The radial section 20, in turn, is characterized by a grip body portion 40 having and surrounding a mounting bore 42 which extends through the long axis of the grip body 40. The mounting bore 42 is designed for receiving a hand-held writing instrument, such as a pen or pencil. The mounting bore 42 defines an x-axis of an x-y-z coordinate system, in which x, y, and z, are oriented perpendicular to one another. Optionally, the mounting bore 42 can be circular in cross-section and can have dimensions that are slightly smaller that the outer dimensions of a pencil or a pen, so that it can frictionally hold such pencil or pen in place when the gripping aid is in use for writing. Or, the mounting bore 42 can be hexagonal or octagonal or any other shape that can accommodate the outer physical characteristics of any writing instrument.

The grip body 40 further includes lateral surfaces 44 and 46 each of which includes a generally concave surface 54 and 56 respectively, and located relatively closer to the distal end 49 of the grip body 40 than the proximal end 48 of the grip body 40. Concave surfaces 54 and 56 each has a shape and size suitable for receiving a portion of the distal phalanx of the thumb or index finger.

Each of the lateral surfaces 44 and 46 includes a raised surface 64 and 66 that is relatively more elevated in the respective z-direction than respective generally concave surfaces 54 and 56 and that is located relatively near the distal body end 49. Each lateral surface 44 and 46 respectively, progressively rises in elevation in the respective z-direction from the generally concave surface to the raised surface. The angle and height of this rise in elevation is appropriate to rotate the thumb and index finger out to assure proper positioning of the thumb and index fingers and create an open and circular web space, and for support of thumb and index finger joints to discourage joint hyper-extension.

Further, the lateral surfaces 44 and 46 are substantially identical to one another in shape and in position on the grip body 40. One lateral surface provides contact with the end of a thumb and portion of the thumb between the thumb end and the adjacent thumb joint, and supports the thumb joint, whereas the other lateral surface provides contact with the distal phalanx, and support the DIP joints of either the index finger, or both the index finger and the middle finger juxtaposed thereto.

In addition the grip body 40 includes a raised ridge 70 that has a distal end 72, which in turn has a relatively more elevated cross-section in a y-direction relative to the x-axis, than the proximal end 71 thereof. As clearly shown in the figures, raised ridge 70 is progressively more elevated in the y-direction as it extends from proximal ridge end 71 toward distal ridge end 72 until it reaches a locus E of maximum elevation in the y-direction located near distal ridge end 72. As also illustrated, raised ridge 70 is generally arched.

Finally, the underside of the grip body 40 can optionally include a longitudinally extending very slight and gentle saddle 80 for receiving and supporting the distal and intermediate phalangees for the thumb or alternatively the middle finger.

While particular embodiments of the invention have been illustrated and described in detail herein, they are provided by way of illustration only an should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

Accordingly, I claim:

1. A gripping aid for use in connection with a hand-held writing, drawing and painting instrument comprising a single unitary body having a radial section fixedly connected to an ulnar section.

2. The gripping aid of claim 1, wherein the radial section supports the radial part of the hand and the ulnar section supports the ulnar section of the hand.
